(19) United States
(12) Patent Application Publication
(10) Pub. No.: US 2003/0170353 A1
(43) Pub. Date: Sep. 11, 2003

(54) Protein coated gas microbubbles

(75) Inventor: Cornelis Van Vliet, Vlaardingen (NL)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/323,285

(22) Filed: Dec. 19, 2002

(30) Foreign Application Priority Data
Dec. 21, 2001 (EP) 01205063.9

(51) Int. Cl. A23L 3/00

(52) U.S. Cl. 426/238

(57) ABSTRACT

The invention relates to a process for the preparation of a food product comprising the steps of: (a) preparing a mixture comprising protein and water; (b) adjusting the pH of the mixture to a value within the range of 2.0-11.0; (c) pre-incubating the mixture; (d) subjecting the mixture to a sonication treatment or a high shear mixing treatment; (e) optionally, separating the product of step (d) in a fraction rich in gas microbubbles and a fraction poor in gas microbubbles; (f) drying the mixture and/or fraction comprising protein coated gas microbubbles until dried protein coated gas microbubbles are obtained; (g) using the dried protein coated gas microbubbles in part or in whole as a food ingredient and (h) finishing the preparation of the food product.

### FIELD OF THE INVENTION

The invention relates to a process for the preparation of protein coated gas microbubbles. The invention further relates to an anti-spattering agent.

### BACKGROUND OF THE INVENTION

WO-A-038547 discloses a process for the preparation of protein coated gas microbubbles, wherein a solution or dispersion of a protein is contacted with gas, using a sonication apparatus. According to WO-A-038547, the protein coated gas microbubbles are substantially dispersed in the aqueous phase of a food product, such as for example a spread, mayonnaise, dairy product, dressing or ice cream.

European Application EP-01200309.1 describes products comprising protein coated gas microbubbles, with improved storage stability with respect to spattering performance. The products are characterised by an aqueous phase having a pH of 2.5 to 6. Globular proteins, such as whey proteins, glycinins, conglycinin, potato proteins, pea proteins, transferrins and albumins are mentioned as suitable proteins for the coating of the microbubbles. According to EP-01200309.1, the addition of an edible salt increases the stability and spattering performance because the protein microbubbles form aggregates, observable under the microscope as lump-like structures in which multiple protein coated microbubbles are connected to each other in some way.

A disadvantage according to the prior art is, that if the product, such as a spread, is prepared in a process involving a high temperature, high pressure or high shear step, this results in a loss of protein coated gas microbubbles and thus a loss of anti-spattering functionality.

### SUMMARY OF THE INVENTION

An object of the invention is to reduce loss of protein coated gas microbubbles during processing of a food product comprising the microbubbles.

According to the invention, protein coated gas microbubbles may be dried, for instance by spray drying or freeze-drying. Surprisingly, we have found that protein coated microbubbles are rigid enough to survive the spray drying or freeze drying process, without substantial loss in yield and spattering performance. The dried protein coated gas microbubbles may be used as an universal anti-spattering agent. The dried protein coated gas microbubbles have an improved microbiological stability. They may be added to any food product.

The invention further relates to a food product, comprising protein coated gas microbubbles, being an oil, a shortening, a spray product, a sauce, a coating, a marinade, and/or a seasoning.

### DETAILED DESCRIPTION OF THE INVENTION

The following definitions will be used throughout the description and claims. Where ranges are mentioned, the expression from a to b is meant to indicate from and including a, up to and including b, unless indicated otherwise. The term's ‘oil’ and ‘fat’ may be used interchangeably.

The term gas microbubbles refers to individual gas units, which are all part of a dispersed gas phase. Gas microbubbles are herein defined as gas bubbles which have a mean diameter size distribution with a maximum below 10 μm. Mean diameters are herein defined as D(3,3) and may be determined as given under examples. Usually the gas microbubbles have a mean diameter above 0.1 μm. The advantageous effects in reduced spattering and increased storage stability can only be obtained if the gas is dispersed in the form of small gas microbubbles, having a mean diameter size distribution with a maximum below 10 μm, preferably below 5 μm, more preferably below 3 μm, even more preferably below 2 μm, most preferred below 1 μm. A method to determine the mean diameter size distribution of said gas microbubbles is illustrated in the examples. The size distribution may be altered by fractionation into larger or smaller microbubble populations. Coated gas microbubbles are herein defined as gas microbubbles having a coating and a mean diameter size distribution with a maximum below 10 μm (including the thickness of the coating). Protein coated gas microbubbles are such microbubbles wherein the coating substantially consists of one or more proteins, preferably at least 90 wt. % of the coating.

The solution or dispersion of protein according to the invention is a mixture of a solvent for the protein and protein, wherein preferably at least part of the protein is dissolved in the solvent. The solvent may be any solvent. Preferably the solvent is edible, most preferably the solvent is water or mixtures of water and other solvents, having water as the main solvent. Preferably essentially all protein present is dissolved in the solvent phase. Most preferably the solution is a clear solution. The turbidity of the solution or dispersion of protein may indicate the presence of protein aggregates and/or impurities that interfere with the formation of protein coated gas microbubbles.

“Protein” as used herein is any protein capable of forming a coating around gas microbubbles. Examples of such proteins are: whey proteins, glycinins, conglycinin, potato proteins, pea proteins, transferrins and albumins. Examples of albumins are serum albumin and ovalbumin. “Protein” is herein defined to include mixtures of proteins and mixtures of protein and other constituents, such as egg white and serum.

Whey protein is herein defined as protein derived from milk and it includes β-lactoglobulin. Though not wishing to be bound by theory, it is believed that the protein responsible for forming the coating for the microbubbles is β-lactoglobulin, which is present in whey in a substantial amount. Whey is a by-product of cheese and casein production that remains after the selective coagulation of the casein. Preferably the whey protein comprises a high concentration of β-lactoglobulin, for instance at least 20 wt. %, preferably at least 40 wt. %.

“Native whey protein” is herein defined as whey protein having a low amount of aggregates of whey protein. Such “native whey protein” may be characterised by the fact that it is soluble in water. Preferably the presence of non-water soluble whey products is avoided. The degree of denaturation of protein is determined herein by nitrogen solubility index (NSI) at pH 4.6 according to de Wit, J. N., G. Klarenbeek,& E. Hontelez-Backx: Evaluation of functional properties of whey protein concentrates and whey protein isolate 1. Isolation and characterization, Netherlands Milk and Dairy Journal 37, 37-49 (1983).

Casein is preferably essentially absent in the solution or dispersion of the whey protein, since casein interferes with the formation of protein coated gas microbubbles. The amount of casein should preferably be lower than 5 wt. % casein relative to the amount of whey protein, preferably less than 1 wt. %, more preferably below 0.5 wt. % casein. Casein peptides and/or fragments, for examples such as peptides produced in the proteolytically cleavage of casein, may be present.

Native whey protein may be used according to the invention as such or in the form of whey products that contain a substantial amount of native whey protein. Whey products containing a high amount of native whey protein are prepared in a process where heat treatment, causing substantial denaturation of the whey protein has been essentially avoided, such as for instance a process using ultrafiltration. An example of a commercially available whey product with native whey protein is: Ultra whey-99 available from Volactive (United Kingdom) containing 94 wt. % protein.

Preferably the native whey protein used according to the invention comprises a low amount of lactose and fatty acid. More preferably, the lactose content is 10 wt. % or lower, most preferably 4 wt. % or lower.

In the preparation of the microbubbles, the solution or dispersion of protein may be obtained by mixing protein and solvent such as water. The mixing of protein and water can be done in a known manner. The amount of protein in the mixture should be so high that at least a partial coating around the gas microbubbles is attained. Also the amount should be such that enough microbubbles are attained. The upper limit of the amount may be determined by the dispersibility or solubility of the protein in water. The protein concentration is preferably from 0.1 to 30 wt. %, more preferably from 0.1 to 10 wt. %, most preferably 0.5-8 wt. %. For whey protein, the protein concentration is preferably 0.5-15 wt. %, more preferably 5-10 wt. %.

The invention further relates to a process for the preparation of a food product comprising the steps of:

(a) preparing a mixture comprising protein and water;

(b) adjusting the pH of the mixture to a value within the range of 2.0-11.0;

(c) pre-incubating the mixture;

(d) subjecting the mixture to a sonication treatment or a high shear mixing treatment;

(e) optionally, separating the product of step (d) in a fraction rich in gas microbubbles and a fraction poor in gas microbubbles;

(f) drying the mixture and/or fraction comprising protein coated gas microbubbles until dried protein coated gas microbubbles are obtained;

(g) using the dried protein coated gas microbubbles in part or in whole as a food ingredient;

(h) finishing the preparation of the food product.

These steps will be described below in more detail.

(a) Preparing a Mixture Comprising Protein and Water

The mixture of protein and water prepared in this step may be a dispersion or preferably a solution. The proteins used in the mixture may be any protein capable of forming a coating around gas microbubbles. Preferred proteins are chosen from the group of globular proteins. Examples of suitable globular proteins are whey proteins, glycinins, conglycinin, potato proteins, pea proteins, transferring and albumins. Especially preferred proteins are chosen from the group of the whey proteins or albumins.

“Protein” is herein defined to include mixtures of proteins and mixtures of protein and other constituents, such as egg white and serum. Crude egg white and egg white powder etc. may be advantageously used according to the invention as protein.

The mixing of protein and water can be done in a known manner. The amount of protein in the mixture should be so high that at least a partial coating around the gas microbubbles is attained. Also the amount should be such that enough microbubbles are attained. The upper limit of the amount may be determined by the dispersibility or solubility of the protein in water. The protein concentration is preferably from 0.1 to 30 wt. %, more preferably from 0.5 to 10 wt. %, most preferably 0.5-8 wt. %.

According to a preferred embodiment, the mixture in step (a) is prepared under stirring until a homogeneous mixture is formed. Homogeneous in this context is meant to indicate that said compound is present in the aqueous phase and essentially no residue is present on the bottom of a jar in which the mixture is prepared if stirring is stopped.

In step (a) also other ingredients that are part of an optional aqueous phase of the shallow frying product may be added. Such ingredients are for example water-soluble flavours, dairy ingredients such as buttermilk powder or whey powder, colourants, stabilisers, gelling agents or thickeners, salts and the like. However, preferably such ingredients are added after the microbubbles have been prepared, i.e. after step (d). Optionally after step (a), excess ingredient that has not solubilized but forms a residue is removed by centrifugation or filtration, e.g. ultrafiltration or a similar separation technique.

The pressure in step (a) is not critical. Preferably the pressure is from 0.5 to 4 bar, most preferred is atmospheric pressure.

The temperature in step (a) is not critical, as long as it is not so high that substantial thermal decomposition of the protein occurs. This temperature depends on the type of protein. Generally preferred temperatures are from room temperature (20° C.) to 80° C., more preferably from 40° C.-60° C.

(b) Adjusting the pH of the Mixture to a Value Within the Range of 2.0 to 11.0

The pH of the mixture to be subjected to sonication is found to be important. The desirable pH is adjusted in step (b). The following pH ranges for different proteins were found to give the highest microbubble yield.

For serum albumins the preferred pH range is 2.0-9.0, most preferred 2.7-4.1. For egg white protein the preferred pH range is 3.5-4.1. For soy protein the preferred pH range is 5.5-9.0, most preferred the pH is in the range of 6.7-7.3. For whey protein the preferred pH range is 8.5-10.5.

Adjustment of pH, in step (b) but also in other steps herein, may be done in a known manner, e.g. by addition of acid or base. The pH may be measured during step (b) in order to allow addition of the right amount of acid or base, for instance by using a pH-meter. Preferably acids or bases are used that are acceptable for addition in food products. The acids may be organic or inorganic. Most preferred acids are citric acid, lactic acid and/or acetic acid. Most preferred bases are sodium hydroxide. Temperature and pressure are not critical as long as they are within ranges where no substantial decomposition of the protein occurs.

Step (a) and step (b) may be combined.

(c) Pre-Incubating the Mixture

Preferably after step (a) and/or (b) the protein mixture is subjected to pre-incubation step. The pre-incubation step is a step wherein the mixture is allowed to rest for a certain time. The pre-incubation time may be from 1 minute to several hours, preferably from 10 minutes to 2 hours most preferably around 30 minutes in a batchwise process. In a continuous process the comparative incubation times (residence time) are preferred.

The pH of the mixture in step (c) may be about the same as at the end of step (b). The temperature in the pre-incubation step should be below about 90° C., since at higher temperatures the protein may decompose or polymerise in a way, which deteriorates microbubble formation in step (d).

The optimum pre-incubation temperature is dependent on the type of protein, more specifically related to the denaturation temperature of the protein. Preferably the pre-incubation temperature is 30-90° C. Preferably the pre-incubation temperature is about 2 to 20 degrees lower than the denaturation temperature of the protein, preferably 5-10 degrees lower than this denaturation temperature. Most preferred ranges for the pre-incubation temperature are 45-55° C. for serum albumin, 75-85° C. for glycinin 11S, 60-70° C. for ovalbumin, 35-45° C. for conalbumin and 60-70° C. for beta-lactoglobulin. Denaturation temperatures of a protein or mixtures containing a protein may be determined using circular dichromism techniques, known to the person skilled in the art. Though not wishing to be bound to theory, it is believed that during the pre-incubation step, under the influence of temperature, the protein chains will fully or partly unfold.

(d) Subjecting the Mixture to Gas, for Instance to a Sonication or High Shear Mixing Treatment

According to step (d) the mixture is subjected to gas, for instance by sonication or high shear mixing.

(1) Sonication

Sonication may be carried out by immersing a sonicator tip into the mixture or by putting said mixture in a sonicating bath. For the indicated method of sonication, any type of sonicator providing enough energy for the microbubble formation can be used. Preferably the type of sonicator, and the dimension of the sonicator tip or horn are chosen such that they are in accordance with the volume of the mixture that is subjected to sonication. The sonication treatment can be carried out in the pulsed mode or in the continuous mode, whereby the pulsed mode is preferred. Advantageously flow-through sonicators are used, since these allow continuous operation of the process.

Preferably sonication is carried out under conditions comparable to those of the sonication method as used in the examples, however adapted for industrial scale of the process, based on the knowledge of the person skilled in the art, such as for instance illustrated in EP-B 0359246. According to the method of the examples, the sonicator is of the Branson model 450, with a 0.5 inch probe. A beaker of 150 cm³ is half-filled with the indicated mixture. The power level during sonication is 8 and the duty cycle in pulsed mode is preferably 30%. It has been found that gas (e.g. air) is easily dispersed in the sonicated mixture if sonication is applied. Through cavitation due to the sonification air may be drawn into the protein containing mixture and microbubbles may be formed. Alternatively sonication may be conducted under stirring. Stirring is preferably moderate or vigorous, whereby for example 200 to 10.000 rpm is applied for a volume of about 50-500 ml. Preferably stirring is such that a foam is formed on the surface of the sonicated mixture.

(2) High Shear Mixing

The mixture may be subjected to high shear mixing using known apparatus that generate high shear conditions, for instance a high speed mill or mixer. Examples of such apparatus are given in EP-B-633030, page 7, line 35 to page 8, line 45 and FIGS. 1 to 3. Examples are a Gaulin mill, a Bernatek mill or a Silverson mill.

Sonication or high shear mixing is advantageously conducted in an atmosphere of gas, which may be incorporated in the protein coated microbubbles. For example nitrogen or argon can be present. Also air is a suitable composition for the process of the current invention. According to a further embodiment the mixture is sparged with a suitable gas or mixture of gases as indicated above. Sparging can be carried out at any time during the preparation steps (a) to (d) according to the invention. Thus said sparging can be carried out before sonicating or high shear mixing said aqueous mixture to saturate the mixture with said gas composition (e.g. in step (a)) or during sonication (in step (d)). A combination of these methods is also possible.

Sonication or high shear mixing may be carried out under atmospheric pressure. It is also possible to work under reduced or increased pressure. However care should be taken that the sonication/mixing conditions are chosen such that the gas microbubbles that are formed in the product according to the invention do not collapse due to overpressure and do not burst due to under-pressure.

In a preferred process, if a certain pressure is applied during preparation of microbubbles in the aqueous phase, said pressure is remained throughout additional process steps. Preferably in step (d) a pressure of from 0.5 to 4 bar, preferably from 0.8 to 2.5 bar, most preferred atmospheric or near atmospheric pressure is applied. Said pressure can be created using any of the gas compositions as indicated above.

Though sonication and high shear mixing may in principle be carried out at any given temperature, it will be appreciated that the presence of heat sensitive compounds, like proteins, should be taken into account when choosing the desired temperature. Preferably sonication is carried out around temperatures below the denaturation temperature of proteins if there are any proteins present; this to prevent denaturation and subsequent precipitation of said proteins.

Preferably in step (d) said mixture is at a temperature of from 30-90° C., preferably from 35-75° C. Especially suitable temperatures of sonication are from 50 to 74° C. for soy proteins and 45 to 55° C. for ovalbumin, for egg white protein, for whey protein and serum albumins, since at these temperatures high yields of microbubbles are obtained.

Preferably the amount of gas microbubbles in the starting material after sonication or high shear mixing is such that the aqueous phase comprises from 1 exp07 to 2 exp12 gas microbubbles per cm³.

The gas microbubble mean diameter size in the sonicated material is preferably in accordance with the distribution desired for the final product. When water droplet are present in the food product, the mean diameter of the protein coated gas microbubbles is preferably smaller than the mean diameter of the water droplets and more preferably substantially smaller.

Therefore, preferably an average diameter of protein coated gas microbubbles of about 2 to 5 μm is desired in a water-in-oil emulsion which will be applied in a frying product, that shows reduced spattering.

The aqueous phase with gas microbubbles prepared in step (d) can be used as such but it can also be combined with further ingredients of the aqueous phase followed by combination with other ingredients, for example a fatty phase and/or any of the other ingredients that are suitable ingredients for food products according to the invention, such as those indicated above.

(e) Optionally, Separating the Product of Step (d) in a Fraction Rich in Gas Microbubbles and a Fraction Poor in Gas Microbubbles

The mixture with gas microbubbles prepared in step (d) may optionally be subjected to centrifugation, (ultra)filtration or similar separation techniques. The separation step is optionally preceded by a resting treatment. During such a resting treatment the aqueous phase is preferably stored at a temperature of from 0 to 15° C., whereby the larger gas microbubbles are allowed to float to the surface of the system. Said larger bubbles may be removed by decantation. The resulting aqueous mixture, which comprises relatively small gas microbubbles may then be centrifuged at low velocity for example around 800 rpm. In such a centrifuging treatment gas microbubbles are concentrated in the upper part of the system and water comprising an increased amount of gas microbubbles can easily be decanted. Herewith an aqueous mixture with an increased content of relatively small gas microbubbles can be obtained. Moreover by this treatment compounds such as protein that does not participate in the gas microbubble coating can be separated out.

The separation step (e) may be executed in such way that more than one subtraction rich in gas microbubbles are obtained and/or more that one subtractions poor in gas microbubbles are produced. Subfractions rich in microbubbles may be mixed with one another, as may fractions poor in gas microbubbles, before further processing.

Preferably the fraction poor in gas microbubbles is recycled to step (a) or (b). We have found that recycled protein in the fraction poor in gas microbubbles is still suitable for the reparation of gas microbubbles. We have found that at least five times recycling is possible. Recycling considerably increases the economy of the process, because protein losses are minimized.

Step (e) may be omitted in case the product of step (d) has such composition that it can directly be used in the preparation of a food product.

(f) Drying the Mixture and/or Fraction Comprising Protein Coated Gas Microbubbles Until Dried Protein Coated Gas Microbubbles are Obtained

In step (f), optionally the mixture obtained in step (d) or (e) is subjected to a drying treatment, in which the solvent (e.g. water) and other fluids are removed from the mixture until dried protein coated gas microbubbles are obtained. The drying of the dried protein coated gas microbubbles may be executed according to any known drying technique. An overview of drying techniques is given in Perry's Chemical Engineers' Handbook, 7^{th} edition, Mc Graw-Hill, NY, USA, in the table on pages 12-39 to 12-41.

The temperature at which the drying takes place is important since in case the temperature is too high, the protein coated gas microbubbles may burst and the protein coating may decompose. Also the time during which the protein is exposed to a high temperature is important. The temperature in the drying step (f) is preferably below 120° C., more preferably below 90° C., most preferably below 80° C. Preferred drying techniques are spray drying and freeze drying, since these techniques may be used at low temperatures and/or short contact times.

During the freeze-drying or spray-drying step functional ingredients, may be added to the microbubbles dispersion before the spaying or freezing, such that these functional ingredients are present in the dried microbubble. Such functional ingredients may for instance be added to improve the stability or the structure of the dry microbubbles. Ingredients with other functionalities may also be used. Examples of functional ingredients are maltodextrin and salt. Alternatively the microbubbles dispersion may mixed with functional ingredients during or after the drying step, e.g. by spraying the dispersion onto the functional ingredient.

The invention further relates to dried protein coated gas microbubbles. Dried herein means a low water (or solvent) content such that the material containing the microbubbles is pulverous. Preferably the protein coated gas microbubbles are dried until a free flowing powder is obtained. More preferably the protein coated gas microbubbles are dried until a powder is obtained having a water content of 10 wt. % or lower, more preferably 5 wt. % or lower. A low water content increases the microbiological stability of the protein coated gas microbubbles.

(g) Using the Dried Protein Coated Gas Microbubbles in Part or in Whole as a Food Ingredient

The dried gas microbubbles prepared in step (f) and/or the product of step (d) can be used as a food ingredient. The dried gas microbubbles may be added to other food ingredients during the preparation of a food product, in a known way, e.g. by mixing.

The dried gas microbubbles may be added to any phase in the prepation of a food product. They may be added to an oil and/or an aqueous phase. The aqueous phase may consist wholly or partly of the aqueous mixture prepared in step (e).

Advantageously an edible salt chosen from group I or group II salts or ammonium salts is added. The edible salt may be added in any of steps (a) to (i). Preferably the salt is added in step (e) or (f) or (g), since if the salt is added before the protein is dissolved, the protein solubility in the mixture of protein and water will be lower. The salt is preferably an edible salt from group II or ammonium halides, sulphates, phosphates or citrates and more preferably the edible salt is sodium chloride. The amount of edible salt is preferably 0.1-10 wt. %, based on the total weight of the food product, more preferably 0.5 to 5 wt. %, most preferably 0.5 to 2 wt. %.

The edible salt increases the stability of the microbubbles and the spattering performance of food products prepared according to the invention. We have observed that when the salt is added to emulsions with protein coated microbubbles at pH of 2.5-6.0, the protein microbubbles form aggregates, observable under the microscope as lump-like structures in which multiple protein coated microbubbles are connected to each other in some way.

(h) Finishing the Preparation of the Food Product

Step (h) may be conducted according to methods known to the person skilled in the art.

Food products according to the invention may be spreads, margarines (water in oil or oil in water emulsions), mayonnaises (oil in water emulsions), dairy products such as fresh cheese (oil in water emulsions) and dressings (oil in water emulsions). For example margarines may be prepared by using a votator process. Cheese can be prepared by for example a standard soft cheese or fresh cheese production process.

A preferred step (h), for the preparation of a liquid margarine, comprises melting a triglyceride oil blend comprising a hardstock fat, and cooling, e.g. in shear mixer such as an A unit, to below the alpha crystallisation temperature and subsequent, or prior to cooling, mixing the triglyceride oil with an aqueous phase. The resulting product is preferably stored at a temperature from 0 to 15° C.

In another preferred step (h) the dried protein coated gas microbubbles may be used as universal anti-spattering agent. They have an improved microbiological stability.

Dried protein coated gas microbubbles may be added to any food product, for instance to oil, to a spray product, a marinade, a sauce, a spread, a liquid shallow frying product and/or a seasoning and added during any stage of a frying and/or cooking process.

Dried protein coated gas microbubbles may be added to a food product in any stage of its preparation process.

A preferred embodiment is an oil-based product containing no or a small amount (<5 wt. %) of water, with 0.1-5 wt. %, preferably 0.1-2 wt. %, more preferably 0.5-1.5 wt. % dried protein coated gas microbubbles.

According to another preferred embodiment the dried protein coated gas microbubbles are used for the preparation of a spreadable margarine or margarine like product, e.g. comprising from 30 to 95 wt. % fat. A preferred process to prepare such a spreadable margarine or margarine like product comprises the steps of emulsification of aqueous phase in a melted fatty phase, mixing the formed emulsion to ensure uniformity, cooling said emulsion in a shear unit, for example a tubular scraped surface heat exchanger, to obtain crystallisation, working the resulting partially crystallised emulsion in for example a pin stirrer unit and packaging the resulting fat continuous product. Optionally before packaging the emulsion is subjected to a resting treatment to increase the final product consistency. Said resting is for example carried out in a resting unit or a quiescent tube. Dried protein coated gas microbubbles may be added at any step in this process. Preferably the dried protein coated gas microbubbles are added after the crystallistion step, e.g. in the resting step. In steps (e) to (h) the pH may be adjusted, in case the pH is not yet within the range of 2.5 to 6. We have found that the optimum pH for production of gas microbubbles may be different from the pH for optimum stability in the food product. Especially in food products that are water and oil comprising emulsions, the pH of the aqueous phase may have an influence on stbility of the protein coated gas microbubbles. The adjustment of pH can be done by addition of acid or base as described under b).

Preferably, when the protein is a serum albumin, the pH of the aqueous phase is adjusted to a value from 2.5 to 4.8, when the protein is egg white protein, the pH of the aqueous phase is adjusted to a value from 3.5 to 4.1 and when the protein is glycinin the pH is adjusted to a value of 6.0 or lower. For whey protein the pH of the aqueous phase is not critical, since whey protein coated gas microbubbles are stable over a broad range of pH's.

The pH in the aqueous phase of a food product being an emulsion is determined as follows. The aqueous phase is separated from the oil phase by heating the food product to 90° C. for 45 minutes and then centrifuging the heated food product at 2800 rotations per minute for 5 minutes. The emulsions are separated due to this treatment into a distinct aqueous phase and a distinct oil phase. The phases were separated through decantation and the pH of the aqueous phase was measured with a pH measuring probe connected to a pH meter. Salt content can be analysed using elemental analysis.

In food products according to the invention the protein coated gas microbubbles can be detected, e.g. by microscopic techniques as described in the experimental part hereof. The type of protein in the gas microbubbles may be determined by amino-acid sequence analysis.

The invention is now illustrated by the following non-limiting examples.

### EXAMPLES

Determination of Spattering Value in a Spattering Test

Primary spattering (SV1) was assessed under standardised conditions in which an aliquot of a food product was heated in a glass dish and the amount of fat spattered onto a sheet of paper held above the dish was assessed after the water content of the food product had been evaporated by heating.

Secondary spattering (SV2) was assessed under standardised conditions in which the amount of fat spattered onto a sheet of paper held above the dish is assessed after injection of a quantity of 10 ml water into the dish.

In assessment of both primary and secondary spattering value, 25 g food product was heated in a 14 cm diameter glass dish on an electric plate set at 205° C. The fat that spattered out of the pan by force of expanding evaporating water droplets was caught on a sheet of paper situated at 25 cm above the pan (SV1 test). Subsequently a quantity of 10 ml water was injected into the dish and again the fat that spattered out of the pan by force of expanding evaporating water droplets was caught on a sheet of paper situated above the pan (SV2 test). In the same way, for marinades the spattering value was determined with a piece of paper situated above the heated pan into which a food product with marinade was fried (SV test).

The images obtained were compared with a set of standard pictures number 0-10 whereby the number of the best resembling picture was recorded as the spattering value. 10 indicates no spattering and zero indicates very bad spattering. The general indication is as follows.

| Score | Comments |
|---|---|
| 10 | Excellent |
| 8 | Good |
| 6 | Passable |
| 4 | Unsatisfactory for SV1, almost |
| | passable for SV2 |
| 2 | Very poor |

Typical results for household margarines (80 wt. % fat) are 8.5 for primary spattering (SV1) and 4.6 for secondary spattering (SV2) under the conditions of the above mentioned test, directly after preparation of the household margarines. The samples at pH 3.5 have good storage stability and good storage stability with respect to spattering performance.

Microscopic Method

Description of the procedure to visualise gas microbubbles in the water phase of a water in oil emulsion.

The microscope that has been used to visualise the gas microbubbles in the water phase is a conical scanning light microscope (CSLM). This instrument is commercially available from a variety of manufactures. The basic principle of CSLM is that in a bulk specimen a stack of in focus slices can be obtained resulting in a 3-D image data set. The microscopy mode is based on visualisation of fluorescently labelled features. To visualise the gas microbubbles a fluorescent dye is brought into contact with the emulsion. The dye diffuses into the emulsion and based on the high affinity of the dye for proteins it is almost exclusively present at the proteins after some time allowing the observation of the protein in the emulsion using CSLM. Since the gas microbubbles are surrounded by a protein layer these gas microbubbles show up in the water droplets as spherical features in which a black hole, being the gas, can be discerned. For the included pictures, the spatial resolution of the light microscope is limited to approximately 0.5 μm. This means that the black hole is not visible in gas microbubbles that are smaller than approximately 1 μm.

Procedure for Visualisation

Approximately 1 g of the emulsion was mixed or shaken gently with 1 drop of the fluorescent dye Rhodamin (0.1% w/v in water), until the Rhodamin solution was completely dispersed in the emulsion. Rhodamin diffuses both through the oil phase and the water phase and is accumulated at proteins and particulate material like emulsifiers. The fluorescent dye was also present at low concentration in the aqueous phase, which resulted in a weak fluorescent signal from the aqueous phase. This allowed localisation and identification of the water droplets in the emulsion.

Part of the stained emulsion was placed in a suitable bulk sample holder that allows observation of an undisturbed not-squeezed part of the emulsion. Using the conical microscope a stack of optical slices were collected. Typical instrumental conditions are optical sections separated 0.5 μm in z-direction using a high magnifying objective lens (for instance 63 times, 1.3 N.A. oil immersion).

Measurement of the Average Mean Diameter of Gas Microbubbles and Microbubble Yield

The number of protein coated gas microbubbles in the water phase was determined as follows:

The microbubble solution is put in a microscopic counting chamber; layer thickness 10 μm.

The microscope is a Zeiss Axioplan 2 using phase contrast. Using this phase contrast option the microbubbles become visible as bright spots. The magnification is 40×1.6×0.63 (objective is 40×). The image is recorded with Sony video camera.

The monitor picture is captured with video capture software using a capture card in a PC. With Image Pro Plus (image analysis software) this captured image is analysed. The number of gas microbubbles is determined using the count/size option of the measurement tool of the software.

The amount of microbubbles counted at a 40× magnitude, using the 0.01 cm counting chamber was divided by the microscopic field volume (2.83×10⁻⁷ ml) which resulted in the amount of microbubbles/ml. For each sample the microbubble were counted 10 times, and the average of the 10 counts was taken as value for microbubble yield.

### Example 1 and Comparative Example A

(a) Dialysis of Whey Protein Solutions

A protein solution (10% w/v of Ultra Whey 99, available from Volactive (UK)) was dialysed using a hollow fiber membrane (Hemofilter Pan 06 from Asahi Medical Co. LTD, MWCO 5,000 Dalton) during 3 hours at 4° C. against demineralized water. In case the solutions were diluted due to the dialysis, they were concentrated up to 7.5% w/v using a concentrating cell (Amicon) containing an ultrafiltration membrane (Diaflo PM10). This dialysed whey solution was used in examples 1-14 and 18.

(b) Preparation of Whey Microbubbles Using an Ultraturrax

The microbubbles were produced using an ultraturrax (Polytron TA 10-35 from Kinematica). Therefore, 50 ml of a dialysed 7.5% w/v whey protein solution in demi water was adjusted to pH 9.5 using 0.2 M NaOH. The solution was pre-incubated for 15 minutes at 65° C. and subsequently ultraturraxed for 1.5 minutes at power level 4. This resulted in an aqueous mixture containing protein coated gas microbubbles.

(c) Preparation of a Liquid Margarine Comprising Protein Coated Gas Microbubbles

A liquid margarine emulsion was made having the following composition: 78 wt. % sunflower oil, 2 wt. % hardstock fat, 20 wt. % demineralized water with microbubbles as prepared under (b). The hardstock fat was a rapeseed oil, hydrogenated until a slip melting point of 70° C. After the emulsions had stabilised, 1.5 wt % NaCl was added. The results are given in table 1.

TABLE 1
Spattering values after different storage times for
liquid margarine, for example 1. MB denotes: Microbubbles

| | | pH | | | | | | | |
|---|---|---|---|---|---|---|---|---|---|
| | | emul- | NaCl | 1 day | | 3 weeks | | 6 weeks | |
| Ex. | MB | sion | (%) | SV1 | SV2 | SV1 | SV2 | SV1 | SV2 |
| 1 | yes | 4.5 | 1.5 | 10 | 8.5 | 10 | 9 | 10 | 9 |

Using protein coated gas microbubbles prepared with an ultraturrax, a liquid margarine with good anti-spattering properties was obtained.

### Example 2

### Spray Dried Whey Microbubbles in 100% Sunflower Oil

A 7.5% w/v Ultra Whey 99 microbubble solution as prepared according to example 1 was spray dried at 65° C., pH 9.5 in a Buchi 190 mini spray drier. 1% w/v of the dried whey-based microbubbles were mixed in 100% sunflower oil during 5 minutes at 1000 rpm. A piece of 50 9 porcine schnitzel was fried in a frying pan in 25 g of the microbubble containing sunflower oil at 190° C. for 3 minutes. For comparison pure sunflower oil was tested (example A). Spattering results are shown in Table 2.

TABLE 2
Spattering values for examples 2 and A

| | | spattering value (SV2) |
|---|---|---|
| Ex. | Composition | after 1 day storage |
| 2 | Sunflower oil with 1 wt. % spray-dried | 8 |
| | whey microbubbles | |
| A | Sunflower oil | 0 |

Table 2 shows that spray dried protein coated gas microbubbles are effective anti-spattering agents, even in plain sunflower oil.

### Examples 3 and 4 and Comparative Experiments B and C

### Spray Dried Microbubbles in a Fish Crispy Coating Mix

A 7.5% w/v Ultra Whey 99 microbubble solution, was spray dried at 65° C. and pH 9.5 in a Buchi 190 mini spray drier. 2.5% w/w of the whey-based microbubbles were added to flour. 40 g of fish was dipped in milk and consequently coated with the flour. In an additional experiment the flour was dissolved in milk first, after which the fish was dipped in this mixture prior to the frying. The fish was fried in 25 g pure sunflower at 190° C. in a frying pan, for 3 minutes. Spattering results are shown in Table 3.

TABLE 3
Spattering values for fish marinade

| Ex. | Composition | SV |
|---|---|---|
| B | Fish + flour/milk mix | 5.5 |
| 3 | Fish + flour/milk mix with microbubbles | 7.5 |
| C | Fish marinated with flour | 7.5 |
| 4 | Fish marinated with flour and microbubbles | 8.5 |

Table 3 shows that a coating mix comprising protein coated gas microbubbles can be made and the microbubbles have an anti-spattering effect.

### Example 5

### Spray Dried Whey Microbubbles in an Oil-Based Frying Product Containing Substantially No Water

A 7.5% w/v Ultra Whey 99 microbubble solution, was spray dried at 65° C. and pH 9.5 in a Buchi 190 mini spray drier. 1% w/v of the dried whey microbubbles were mixed into Combi Phase (an oil-based frying product for the professional market containing substantially no water, produced by Unilever) during 5 minutes at 500 rpm. A piece of 50 g porcine schnitzel was fried in an induction pan at 250° C. (oil=190° C.) in 25 g of the oil for 3 minutes (the oil was heated-up for 3′). Spattering results are shown in Table 4. Comparative experiment D was executed as example 5, but without gas coated microbubbles.

TABLE 4
Spattering values for oil-based frying product

| Ex. | Composition | SV1 | SV2 |
|---|---|---|---|
| D | Phase without microbubbles | 10 | 6.5 |
| 5 | Phase + 1% spray-dried | 10 | 9 |
| | whey microbubbles | | |

This shows that adding dried microbubbles to a water-free frying product improves the anti-spattering.

### Examples 6 and 7

### Spray Dried Microbubbles in 80/20 Water-In-Oil Emulsion

A 5% w/v Acros Bovine serum albumin (BSA) microbubble solution, prepared like in example 1, was spray dried at 50° C. and pH 3.5 in a Buchi 190 mini spray drier. 1% w/v of these microbubbles was added to the waterphase of an 80/20 water in oil emulsion (contains 2 wt. % hardstock as in example 1 and 1.5% NaCl).

Spray-dried microbubbles (example 7) were compared to microbubbles in aqueous dispersion (example 6). Spattering results are shown in table 7.

TABLE 7
Spattering values

| | | 1 day | | 3 weeks | | 6 weeks | |
|---|---|---|---|---|---|---|---|
| Ex. | Composition | SV1 | SV2 | SV1 | SV2 | SV1 | SV2 |
| 6 | BSA microbubbles, | 10 | 9 | 10 | 9 | 10 | 8.5 |
| | pH 3.5 with 1.5 wt. % | | | | | | |
| | NaCl | | | | | | |
| 7 | spray dried BSA | 10 | 9 | 10 | 8.5 | 10 | 8.5 |
| | microbubbles, | | | | | | |
| | pH 3.5 with 1.5 wt. % | | | | | | |
| | NaCl | | | | | | |

Table 7 shows that spray dried BSA protein coated gas microbubbles dispersed in water result in equal anti-spattering properties compared with a dispersion of (un-dried) BSA protein coated gas microbubbles.

### Example 8

### Spray Dried Microbubbles in a Marinade

A 5% w/v whey protein gas microbubble solution, as in example 1 is spray dried at 50° C., pH 3.5 in a Buchi 190 mini spray drier. 5% w/w of these spray-dried microbubbles were added to a ‘mix for sate marinade’ commercially available at Conimex, Netherlands. To 38 gram of this mixture, 3 tablespoons sunflower oil, 1 tablespoon water and 1 tablespoon soy-sauce (ketjap) were added. About 50 g of porcine schnitzel was mixed with this marinade mix and the schnitzel/marinade mixture was rested for 15 minutes. The marinated schnitzel was shallow fried in a frying pan in 25 g pure sunflower oil at 190° C. for 5 minutes. Spattering results are shown in Table 8.

TABLE 8
Spattering results

| | | SV after 1 |
|---|---|---|
| | | day |
| Ex. | Composition | storage |
| E | oil without microbubbles | 0 |
| F | Marinade without microbubbles | 5.5 |
| 8 | Marinade + 5% ^{w}/_{w} spray dried BSA | 9.5 |
| | microbubbles | |

Table 8 shows that protein coated gas microbubbles may be added to a marinade, which will result in a good anti-spattering effect.

### Example 9

### Spray Dried Microbubbles in a Wrapper Margarine

A 7.5% w/v Ultra Whey 99 microbubble solution was spray dried at 65° C. and pH 9.5 in a Buchi 190 mini spray drier. 1% w/w of the whey-based microbubbles were mixed into a commercial 70 wt. % fat wrapper margarine (Blueband, Unilever, Netherlands). 25 g of the margarine with microbubbles was heated in a glass dish until the frying medium was at 190° C. SV1 and SV2 were measured. For comparison the same margarine without microbubbles was tested (Comparative Ex. G). Spattering results are shown in Table 9.

TABLE 9
Spattering values

| Ex. | Composition | SV1 | SV2 |
|---|---|---|---|
| G | Margarine | 8.5 | 5 |
| 9 | Margarine + 1% spray dried whey | 10 | 8 |
| | microbubbles | | |

Table 9 shows that spray dried whey protein microbubbles may be added to a margarine, which will show reduced spattering.

1. Process for the preparation of a food product comprising the steps of:
(a) preparing a mixture comprising protein and water;
(b) adjusting the pH of the mixture to a value within the range of 2.0-11.0;
(c) pre-incubating the mixture;
(d) subjecting the mixture to a sonication treatment or a high shear mixing treatment;
(e) optionally, separating the product of step (d) in a fraction rich in gas microbubbles and a fraction poor in gas microbubbles;
(f) drying the mixture and/or fraction comprising protein coated gas microbubbles until dried protein coated gas microbubbles are obtained;
(g) using the dried protein coated gas microbubbles in part or in whole as a food ingredient;
(h) finishing the preparation of the food product.

2. Process according to claim 1, wherein in step (f) the dried protein coated gas microbubbles have a water content of 10 wt. % or lower.

3. Process according to claim 1 or 2, wherein in step (d) the mixture is subjected to a high shear mixing treatment.

4. Process according to claim 1 or 2, wherein the drying of the mixture and/or fraction comprising protein coated gas microbubbles in step (f) is conducted using spray-drying and/or freeze drying.

5. Process for the preparation of a food product comprising protein coated gas microbubbles, wherein protein coated gas microbubbles are added to a food product in a process step, that is downstream of processing steps involving high temperature and/or high shear.

6. Free flowing powder of dried protein coated gas microbubbles.

7. Use of dried protein coated gas microbubbles as an anti-spattering agent.

8. Use according to claim 7, wherein the protein substantially consists of whey protein, soy protein, bovine serum albumin and/or egg protein.

9. Food product comprising protein coated gas microbubbles, characterized in that it is an oil, a shortening, a spray product, a sauce, a coating mix, a marinade, and/or a seasoning.

10. Food product according to claim 9, comprising dried protein coated gas microbubbles.
